(19) United States
(12) Patent Application Publication
(10) Pub. No.: US 2026/0279920 A1
(43) Pub. Date: Sep. 17, 2026

(54) SECONDARY BATTERY AND ELECTRIC APPARATUS

(71) Applicant: Ningde Amperex Technology Limited, Ningde (CN)

(72) Inventor: Jun HE, Ningde (CN)

(73) Assignee: Ningde Amperex Technology Limited, Ningde (CN)

(21) Appl. No.: 19/671,866

(22) Filed: May 8, 2026

Related U.S. Application Data
(63) Continuation of application No. PCT/CN2023/130684, filed on Nov. 9, 2023.

(51) Int. Cl. H01M 10/0587; H01M 4/02; H01M 4/525; H01M 4/587; H01M 10/0525; H01M 50/538

(52) U.S. Cl. CPC H01M 10/0587; H01M 4/525; H01M 4/587; H01M 10/0525; H01M 50/538; H01M 2004/021

(57) ABSTRACT

A secondary battery includes an electrode assembly which includes a positive electrode sheet, a negative electrode sheet, and a separator. The positive electrode sheet includes a positive electrode current collector and a positive electrode active material layer. The positive electrode active material layer includes a positive electrode active material. The negative electrode sheet includes a negative electrode current collector and a negative electrode active material layer. The negative electrode active material layer includes a negative electrode active material. The positive electrode current collector as a whole extends to form a plurality of positive electrode tabs, and the negative electrode current collector as a whole extends to form a plurality of negative electrode tabs. A coating weight of the positive electrode active material layer is W_{z}, a coating weight of the negative electrode active material layer is W_{f}, and W_{z} and W_{f} satisfy: 1.6W_{f}≤W_{z}≤2.2W_{f}, and 3.25 mg/cm²≤W_{f}≤5.84 mg/cm².

### CROSS REFERENCE TO THE RELATED APPLICATIONS

This application is a continuation application of International Application No. PCT/CN2023/130684, filed on Nov. 9, 2023, the contents of which are incorporated herein by reference in its entirety.

### TECHNICAL FIELD

This application relates to the field of electrochemical technologies, and in particular, to a secondary battery and an electric apparatus.

### BACKGROUND

Secondary batteries (such as lithium-ion batteries) are featured by high specific energy, high operating voltage, low self-discharge rate, small volume, and light weight, and are widely used in various fields such as electric energy storage, portable electronic devices, and electric vehicles. With the continuous iterative development of consumer lithium-ion batteries in recent years, market requirements for charge speed of the batteries are constantly escalating. As a result, a charge rate of lithium-ion batteries has been continuously improved, with consumer demand gradually increasing from 1 C to above 5 C. However, the improvement of the charge rate of the lithium-ion batteries is often accompanied by the problem of poor processing reliability. Therefore, how to improve cycling kinetic performance of lithium-ion batteries under ultra-fast charge while ensuring processing reliability of the lithium-ion batteries has become an urgent technical problem to be solved by those skilled in the art.

### SUMMARY

The objective of this application is to provide a secondary battery, so as to improve cycling kinetic performance of the secondary battery under ultra-fast charge while ensuring processing reliability of the secondary battery, and an electric apparatus using the secondary battery is provided.

It should be noted that in the summary of this application, this application is explained by using an example in which a lithium-ion battery is a secondary battery, but the secondary battery in this application is not limited to a lithium-ion battery, and may be a secondary battery such as a sodium-ion battery. The specific technical solution is as follows.

In a first aspect of this application, a secondary battery is provided. The secondary battery includes an electrode assembly, where the electrode assembly includes a positive electrode sheet, a negative electrode sheet, and a separator; the positive electrode sheet includes a positive electrode current collector and a positive electrode active material layer; the positive electrode active material layer includes a positive electrode active material; the negative electrode sheet includes a negative electrode current collector and a negative electrode active material layer; and the negative electrode active material layer includes a negative electrode active material; the positive electrode current collector as a whole extends to form a plurality of positive electrode tabs, the negative electrode current collector as a whole extends to form a plurality of negative electrode tabs, a coating weight of the positive electrode active material layer is W_{z}, and a coating weight of the negative electrode active material layer is W_{f}, where W_{z} and W_{f} satisfy: 1.6W_{f}≤W_{z}≤2.2W_{f}, and 3.25 mg/cm²≤W_{f}≤5.84 mg/cm²; and Dᵥ99 of the positive electrode active material is 27 μm to 33 μm, and Dᵥ99 of the negative electrode active material is 23 μm to 28 μm. In this application, the coating weights of the positive electrode active material layer and the negative electrode active material layer, the Dᵥ99 of the positive electrode active material and the negative electrode active material, and the multi-tab structure are comprehensively considered, so that a good synergistic effect is achieved based on comprehensive consideration of the coating weights of the positive electrode active material layer and the negative electrode active material layer, the Dᵥ99 of the positive electrode active material and the negative electrode active material, and the multi-tab structure, thereby improving cycling kinetic performance of the secondary battery under an ultra-fast charge condition while ensuring processing reliability of the secondary battery.

In an implementation of this application, N₁ layers of positive electrode sheets are provided between two adjacent positive electrode tabs, N₂ layers of negative electrode sheets are provided between two adjacent negative electrode tabs, and N₁ and N₂ are independently selected from 0, 1, 2, or 3. N₁ and N₂ are adjusted to be within the above ranges, so that sufficient positive electrode tabs and negative electrode tabs can be provided on the positive electrode sheet and negative electrode sheet in the secondary battery, and then multiple current channels can be provided on the positive electrode sheet and negative electrode sheet, which can reduce an internal resistance of the secondary battery, reduce charge temperature rise, and shorten a charge time of the secondary battery, thereby achieving good cycling kinetic performance of the secondary battery while ensuring processing reliability. It can be understood that N₁ and N₂ may be adjusted to 0 to provide more current channels on the positive electrode sheet and negative electrode sheet, which can further reduce the internal resistance of the secondary battery, further reduce the charge temperature rise and further shorten the charge time of the secondary battery, thereby further improving kinetic performance of the secondary battery while ensuring cycling performance and mechanical reliability, but this reduces the energy density of the secondary battery to a certain extent; and N₁ and N₂ may be adjusted to 1, 2, or 3 to reduce tabs and increase the internal resistance to a certain extent, but this increases the energy density of the secondary battery.

In an implementation of this application, 6.49 mg/cm²≤W_{z}≤11.69 mg/cm². In this application, the coating weight of the positive electrode active material layer is adjusted to be within the range in this application, thereby achieving good cycling kinetic performance of the secondary battery while ensuring processing reliability.

In an implementation of this application, 4.00 mg/cm²≤W_{f}≤5.19 mg/cm², and/or 8.00 mg/cm²≤W_{z}≤10.38 mg/cm². Adjusting W_{z} and/or W_{f} to be within the above ranges optimizes the coating weight range of the positive electrode active material layer and/or the coating weight range of the negative electrode active material layer, further improving cycling kinetic performance of the secondary battery while ensuring processing reliability.

In an implementation of this application, the Dᵥ99 of the positive electrode active material is 28 μm to 31 μm, and/or the Dᵥ99 of the negative electrode active material is 24 μm to 26 μm. Adjusting the Dᵥ99 of the positive electrode active material and/or the Dᵥ99 of the negative electrode active material to be within the above ranges optimizes the range of the Dᵥ99 of the positive electrode active material and/or the Dᵥ99 of the negative electrode active material, further improving cycling kinetic performance and processing reliability of the secondary battery.

In an implementation of this application, the negative electrode active material includes at least one of a carbon-based material, a silicon-based material, or a tin-based material; the carbon-based material includes at least one of natural graphite, artificial graphite, soft carbon, hard carbon, or mesocarbon microbeads; the silicon-based material includes at least one of elemental silicon, a silicon-carbon material, or a silicon-oxygen material; and the tin-based material includes at least one of elemental tin, tin alloy, or tin oxide. The above types of negative electrode active materials have high surface activity, achieving good cycling kinetic performance of the secondary battery while ensuring processing reliability.

In an implementation of this application, the carbon-based material satisfies 0.1≤I_{d}/I_{g}≤1.0, where I_{d}/I_{g} is a peak intensity ratio of a d peak to a g peak measured through Raman test. Applying the carbon-based material satisfying the above I_{d}/I_{g} value to the secondary battery further improves cycling kinetic performance of the secondary battery while ensuring good processing reliability.

In an implementation of this application, the positive electrode active material includes at least one of lithium nickel cobalt manganese oxide, lithium nickel cobalt aluminum oxide, lithium iron phosphate, a lithium-rich manganese-based material, lithium cobalt oxide, lithium manganese oxide, lithium manganese iron phosphate, or lithium titanate. The above types of positive electrode active materials have high surface activity, achieving good cycling kinetic performance of the secondary battery while ensuring processing reliability.

In an implementation of this application, the positive electrode active material further includes a non-metal element, and the non-metal element includes at least one of fluorine, phosphorus, boron, chlorine, silicon, or sulfur. Including the above types of non-metal elements in the positive electrode active material can further improve the stability of the positive electrode active material.

In a second aspect of this application, an electric apparatus is provided, including the secondary battery described in any one of the foregoing implementations. Therefore, the electric apparatus exhibits good use performance.

Beneficial effects of this application are as follows.

This application provides a secondary battery and an electric apparatus. In the secondary battery, the positive electrode current collector as a whole extends to form a plurality of positive electrode tabs and the negative electrode current collector as a whole extends to form a plurality of negative electrode tabs, providing a multi-tab structure for the secondary battery. In addition, the Dᵥ99 of the positive electrode active material and the Dᵥ99 of the negative electrode active material are adjusted to be within the ranges of this application, and the coating weights of the positive electrode active material layer and the negative electrode active material layer and a relationship thereof are adjusted to be within the ranges of this application, so that a good synergistic effect is achieved between the multi-tab structure of the secondary battery, the Dᵥ99 of the positive electrode active material and the negative electrode active material, the coating weight of the positive electrode active material layer, and the relationship between the coating weights of the positive electrode active material layer and the negative electrode active material layer. In this case, a lithium ion transmission path inside the positive/negative electrode active material during the transmission is shorter, and a transmission distance and transmission tortuosity inside the positive/negative electrode sheet are smaller, to reduce the concentration polarization of the secondary battery, and reduce a probability of breakage of the positive electrode sheet and the negative electrode sheet, thereby improving cycling kinetic performance of the secondary battery when the secondary battery experiences ultra-fast charge while ensuring processing reliability of the secondary battery. The electric apparatus in this application exhibits good use performance.

### BRIEF DESCRIPTION OF DRAWINGS

The accompanying drawings described herein are used to provide a further understanding of this application and constitute a part of this application. The schematic embodiments and descriptions thereof in this application are used to explain this application and do not constitute an improper limitation on this application.

FIG. 1 is a schematic structural diagram of an electrode assembly in an implementation of this application;

FIG. 2 is a schematic structural diagram of an electrode assembly in another implementation of this application;

FIG. 3 is a schematic structural diagram of a positive electrode sheet in an implementation of this application;

FIG. 4 is a schematic structural diagram of a negative electrode sheet in an implementation of this application; and

FIG. 5 is a Raman spectrum of a negative electrode in Example 2-3.

### DETAILED DESCRIPTION

In order to make the objectives, technical solutions, and advantages of this application clearer, this application will be further described in detail below with reference to the accompanying drawings and embodiments. It is clear that the described embodiments are only some but not all embodiments of this application. All other embodiments obtained by those skilled in the art based on this application belong to the protection scope of this application.

It should be noted that in some embodiments of this application, this application is explained by using an example in which a lithium-ion battery is a secondary battery, but the secondary battery in this application is not limited to a lithium-ion battery and may alternatively be a secondary battery such as a sodium-ion battery.

In a first aspect of this application, a secondary battery is provided, where the secondary battery includes an electrode assembly; the electrode assembly includes a positive electrode sheet, a negative electrode sheet, and a separator; the positive electrode sheet includes a positive electrode current collector and a positive electrode active material layer; the positive electrode active material layer includes a positive electrode active material; the negative electrode sheet includes a negative electrode current collector and a negative electrode active material layer; the negative electrode active material layer includes a negative electrode active material; the positive electrode current collector as a whole extends to form a plurality of positive electrode tabs; the negative electrode current collector as a whole extends to form a plurality of negative electrode tabs; a coating weight of the positive electrode active material layer is W_{z}; a coating weight of the negative electrode active material layer is W_{f}, and W_{z} and W_{f} satisfy: 1.6W_{f}≤W_{z}≤2.2W_{f}, and 3.25 mg/cm²≤W_{f}≤5.84 mg/cm²; Dᵥ99 of the positive electrode active material is 27 μm to 33 μm, and Dᵥ99 of the negative electrode active material is 23 μm to 28 μm.

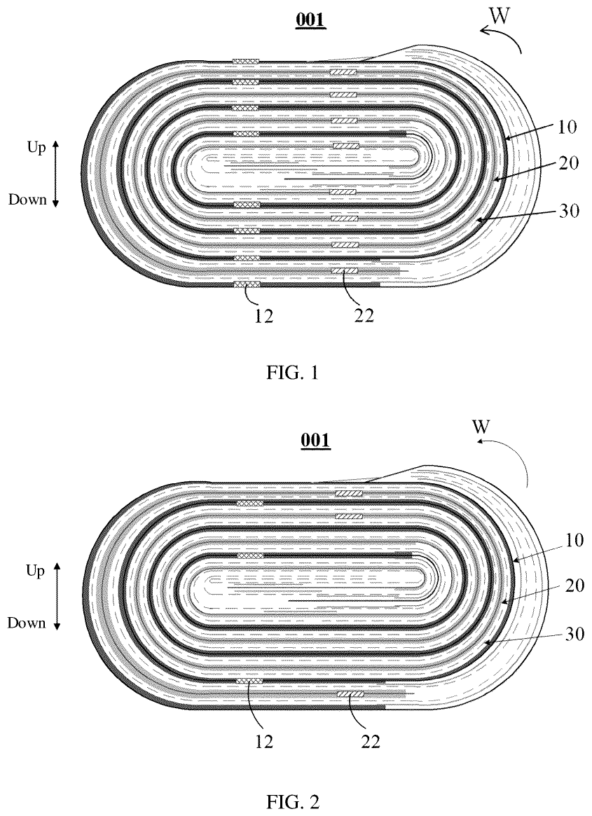

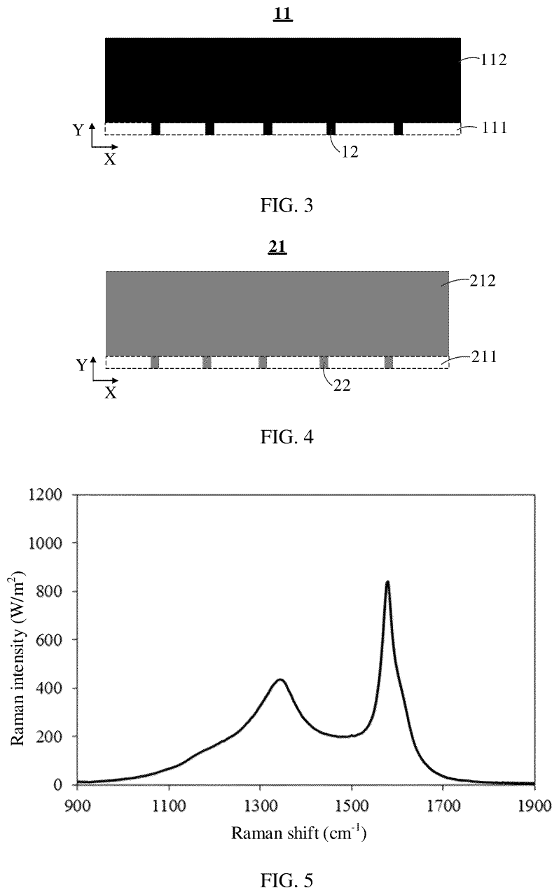

In this application, for ease of understanding, a length direction of the separator in an unfolded state is defined as X, a width direction of the separator is defined as Y, and a thickness direction of the separator is defined as Z. It can be understood that the length directions, width directions, and thickness directions of the positive electrode sheet and the negative electrode sheet in an unfolded state are the same as those of the separator. After the positive electrode sheet, the separator, and the negative electrode sheet are wound to form a wound electrode assembly, a winding direction of the electrode assembly is W. As shown in FIG. 1 and FIG. 2, the electrode assembly 001 includes a positive electrode sheet 10, a negative electrode sheet 20, and a separator 30, where the separator 30 is provided between the positive electrode sheet 10 and the negative electrode sheet 20. The positive electrode sheet 10 includes a positive electrode current collector 11. As shown in FIG. 3, the positive electrode current collector 11 as a whole extends to form a plurality of positive electrode tabs 12, where the positive electrode current collector 11 includes a positive electrode tab region 111 and a positive electrode main body region 112. It can be understood that the positive electrode tab region 111 is a region provided with the positive electrode tab 12, and the positive electrode main body region 112 refers to a region of the positive electrode current collector 11 other than the positive electrode tab region 111. The negative electrode sheet 20 includes a negative electrode current collector 21. As shown in FIG. 4, the negative electrode current collector 21 as a whole extends to form a plurality of negative electrode tabs 22, where the negative electrode current collector 21 includes a negative electrode tab region 211 and a negative electrode main body region 212. It can be understood that the negative electrode tab region 211 refers to a region provided with the negative electrode tab 22, and the negative electrode main body region 212 refers to a region of the negative electrode current collector 21 other than the negative electrode tab region 211. In this application, the above description “as a whole extend” means that the current collector and the tab are formed integrally, for example, a plurality of tabs are obtained through cutting such as laser or die-cutting at the edge of the current collector, rather than being connected to the current collector by non-integral formation means such as welding. It should be noted that a quantity, shape, and size of the positive electrode tabs and negative electrode tabs in FIG. 1 to FIG. 4 are only for exemplary illustration, and this application is not limited thereto. In this application, the above description “a plurality of” refers to two or more. In an implementation of this application, “a plurality of” refers to at least two, and the upper limit of the quantity of tabs may not be particularly required, and is adjusted according to factors such as the capacity and size of the secondary battery. For example, 2, 3, 4, 5, 6, 7, 20, or 50 tabs may be provided.

For example, W_{z} is 1.6W_{f}, 1.7W_{f}, 1.8W_{f}, 1.9W_{f}, 2.0W_{f}, 2.1W_{f}, 2.2W_{f}, or any value in a range defined by any two of the above values. For example, W_{f} is 3.25 mg/cm², 3.5 mg/cm², 3.75 mg/cm², 4 mg/cm², 4.25 mg/cm², 4.5 mg/cm², 4.75 mg/cm², 5 mg/cm², 5.25 mg/cm², 5.5 mg/cm², or 5.84 mg/cm², or any value in a range defined by any two of the above values. If the coating weight W_{z} of the positive electrode active material layer is less than 1.6W_{f}, a coating weight of the negative electrode active material layer is excessively larger than the coating weight of the positive electrode active material layer, and when a potential of the secondary battery is reached, delithiation of the positive electrode accelerates significantly, resulting in an excessively high actual potential of the positive electrode and easy structural damage, leading to rapid decay of the positive electrode and inability of the secondary battery to cycle normally. If a coating weight W_{z} of the positive electrode active material layer is greater than 2.2W_{f}, the coating weight of the positive electrode active material layer is excessively larger than the coating weight of the negative electrode active material layer, leading to an excessive amount of lithium ion delithiation; and in this case, the negative electrode cannot fully accept the lithium ions deintercalate from the positive electrode, and the lithium ions cannot normally intercalate into the negative electrode sheet, causing lithium precipitation on the negative electrode sheet and affecting cycling kinetic performance of the secondary battery. If the coating weight of the negative electrode active material layer is less than 3.25 mg/cm², the energy density of the secondary battery decreases, and the processing requirements of the secondary battery cannot be satisfied. If the coating weight of the negative electrode active material layer is greater than 5.84 mg/cm², a transmission distance of lithium ions inside the positive electrode sheet and/or the negative electrode sheet increases, increasing the impedance of the secondary battery.

For example, the Dᵥ99 of the positive electrode active material is 27 μm, 28 μm, 29 μm, 30 μm, 31 μm, 32 μm, 33 μm, or any value in a range defined by any two of the above values. If the Dᵥ99 of the positive electrode active material is less than 27 μm, the Dᵥ99 of the positive electrode active material is excessively small, indicating that a volume-based particle size of the positive electrode active material particles is excessively small, and the positive electrode active material particles are prone to agglomeration during the preparation of the positive electrode slurry. In this case, the probability that the positive electrode active material is uniformly dispersed in the positive electrode slurry is extremely small, leading to uneven distribution of the positive electrode active material particles in the formed positive electrode active material layer, affecting the processing stability of the positive electrode sheet, and causing uneven coating problems in the coating process of the positive electrode slurry. Moreover, a specific surface area of the positive electrode active material particles is excessively large, leading to an increase in the interface between the positive electrode active material particles and an electrolyte, intensifying side reactions. Especially under a high kinetic electrolyte system for ultra-fast charge, side reactions are intense, accelerating the consumption of the electrolyte and the generation of side reaction products, deteriorating cycling kinetic performance and processing reliability of the secondary battery. If the Dᵥ99 of the positive electrode active material is greater than 33 μm, the Dᵥ99 of the positive electrode active material is excessively large, a transmission path of lithium ions inside the positive electrode active material particles is excessively long, and a tortuosity of transmission inside the positive electrode sheet is excessively large, leading to excessive concentration polarization inside the secondary battery, thereby increasing the internal resistance of the secondary battery and reducing cycling kinetic performance of the secondary battery.

For example, the Dᵥ99 of the negative electrode active material is 23 μm, 24 μm, 25 μm, 26 μm, 27 μm, or 28 μm, or any value in a range defined by two of the above values. If the Dᵥ99 of the negative electrode active material is less than 23 μm, the Dᵥ99 of the negative electrode active material is excessively small, indicating that the volume-based particle size of the negative electrode active material particles is excessively small, and the negative electrode active material particles are prone to agglomeration during the preparation of the negative electrode slurry. In this case, the probability that the negative electrode active material is uniformly dispersed in the negative electrode slurry is extremely small, leading to uneven distribution of the negative electrode active material particles in the formed negative electrode active material layer, affecting the processing stability of the negative electrode sheet, and causing uneven coating problems in the coating process of the negative electrode slurry. Moreover, a specific surface area of the negative electrode active material particles is excessively large, leading to an increase in the interface between the negative electrode active material particles and an electrolyte, intensifying side reactions. Especially under a high kinetic electrolyte system for ultra-fast charge, side reactions are intense, accelerating the consumption of the electrolyte and the generation of side reaction products, deteriorating cycling kinetic performance and processing reliability of the secondary battery. If the Dᵥ99 of the negative electrode active material is greater than 28 μm, the Dᵥ99 of the negative electrode active material is excessively large, a transmission path of lithium ions inside the negative electrode active material particles is excessively long, and a tortuosity of transmission inside the negative electrode sheet is excessively large, leading to excessive concentration polarization inside the secondary battery, thereby increasing the internal resistance of the secondary battery and reducing cycling kinetic performance of the secondary battery.

Overall, in this application, the positive electrode current collector as a whole extends to form a plurality of positive electrode tabs and the negative electrode current collector as a whole extends to form a plurality of negative electrode tabs, providing a multi-tab structure for the secondary battery. Further, the positive electrode sheet and negative electrode sheet are provided with multiple current channels, reducing the internal resistance of the secondary battery. Under high-rate (such as 5 C to 15 C) charge, voltage polarization of the secondary battery is small, reducing charge temperature rise of the secondary battery and shortening a charge time of the secondary battery, thereby enabling the secondary battery to have high kinetic performance. In this application, the Dᵥ99 of the positive electrode active material and the negative electrode active material are adjusted to be within the above range, so that a lithium ion transmission path inside the positive/negative electrode active material during the transmission is shorter, and transmission tortuosity inside the positive/negative electrode sheet is smaller, to reduce the concentration polarization of the secondary battery, thereby enabling good cycling kinetics of the secondary battery. In this application, the coating weights of the positive electrode active material layer and the negative electrode active material layer are within the above ranges, so that the transmission distances of lithium ions and electrons inside the positive electrode sheet and the negative electrode sheet can be shortened, thereby reducing the ohmic polarization and concentration polarization of the secondary battery. In this application, the coating weights of the positive electrode active material layer and the negative electrode active material layer, the Dᵥ99 of the positive electrode active material and the negative electrode active material, and the multi-tab structure are comprehensively considered, so that a good synergistic effect is achieved based on comprehensive consideration of the coating weights of the positive electrode active material layer and the negative electrode active material layer, the Dᵥ99 of the positive electrode active material and the negative electrode active material, and the multi-tab structure. The positive and negative electrode active materials with relatively small Dᵥ99, matching thin coating required for ultra-fast charge, ensure that large particles in the positive and negative electrode active materials do not exceed a thickness of the active material coating during cold pressing, so as not to squeeze the current collector, reducing the probability of damage and breakage of the current collector. Especially in the multi-tab structure, a gap coating method leads to different stresses on a blank foil area and a coated area due to thickness differences during cold pressing, and therefore breakage is prone to occur when the current collector is squeezed by active material particles. The positive and negative electrode active materials with the relatively small Dᵥ99 in this application match the thin coating required for ultra-fast charge, which can alleviate the breakage caused by squeezing of the current collector by the active material particles, thereby improving cycling kinetic performance of the secondary battery while ensuring processing reliability of the secondary battery.

In this application, the Dᵥ99 represents a particle size where the cumulative distribution by volume reaches 99% as counted from the small particle size side. The “particles” in this application may be particles of the positive electrode active material or particles of the negative electrode active material. Particularly limited in this application on an adjustment method of the Dᵥ99 of the positive electrode active material and the negative electrode active material, as long as the objective of this application can be achieved. For example, the adjustment may be achieved by directly purchasing positive electrode active materials and negative electrode active materials with Dᵥ99 within the range in this application, or by means of crushing, grinding, or ball milling.

In an implementation of this application, N₁ layers of positive electrode sheets are provided between two adjacent positive electrode tabs, and N₂ layers of negative electrode sheets are provided between two adjacent negative electrode tabs, where N₁ and N₂ are independently selected from 0, 1, 2, or 3. As shown in FIG. 1, in a wound electrode assembly, two adjacent positive electrode tabs 12 or two adjacent negative electrode tabs 22 are distributed on different layers. From top to bottom in the figure, 0 layers of positive electrode sheets 10 are provided between two adjacent positive electrode tabs 12, and 0 layers of negative electrode sheets 20 are provided between two adjacent negative electrode tabs 22. As shown in FIG. 2, in the wound electrode assembly, two adjacent positive electrode tabs 12 or two adjacent negative electrode tabs 22 are distributed on different layers. From top to bottom in the figure, 1 layer of positive electrode sheet 10 is provided between two adjacent positive electrode tabs 12, and 2 layers of positive electrode sheets 10 are provided between another two adjacent positive electrode tabs 12; and 0 layers of negative electrode sheets 20 are provided between two adjacent negative electrode tabs 22, and 3 layers of negative electrode sheets 20 are provided between another two adjacent negative electrode tabs 22. N₁ and N₂ are adjusted to be within the above ranges, so that sufficient positive electrode tabs and negative electrode tabs can be provided on the positive electrode sheet and negative electrode sheet in the secondary battery, and then multiple current channels can be provided on the positive electrode sheet and negative electrode sheet, which can reduce the internal resistance of the secondary battery, reduce the charge temperature rise, and shorten charge time of the secondary battery, thereby achieving good cycling kinetic performance while ensuring the fast-charge of secondary and processing reliability. It can be understood that N₁ and N₂ may be adjusted to 0 to provide more current channels on the positive electrode sheet and negative electrode sheet, which can further reduce the internal resistance of the secondary battery, further reduce the charge temperature rise and further shorten the charge time of the secondary battery, thereby further improving kinetic performance of the secondary battery while ensuring cycling performance and mechanical reliability, but this reduces the energy density of the secondary battery to a certain extent; and N₁ and N₂ may be adjusted to 1, 2, or 3 to reduce tabs and increase the internal resistance to a certain extent, but this increases the energy density of the secondary battery.

In an implementation of this application, N₁ layers of positive electrode sheets are provided between two adjacent positive electrode tabs, and N₂ layers of negative electrode sheets are provided between two adjacent negative electrode tabs, where N₁ and N₂ are each independently selected from 0. As shown in FIG. 1, in the wound electrode assembly, two adjacent positive electrode tabs 12 or two adjacent negative electrode tabs 22 are distributed on different layers. From top to bottom in the figure, 0 layers of positive electrode sheets 10 are provided between two adjacent positive electrode tabs 12, and 0 layers of negative electrode sheets 20 are provided between two adjacent negative electrode tabs 22. N₁ and N₂ are adjusted to 0, so that more positive electrode sheets and negative electrode sheets are provided with positive electrode tabs and negative electrode tabs in the secondary battery, and then more current channels are provided on the positive electrode sheet and negative electrode sheet, which can further reduce the internal resistance of the secondary battery, further reduce the charge temperature rise and further shorten the charge time of the secondary battery, thereby further improving kinetic performance of the secondary battery under an ultra-fast charge condition while ensuring cycling performance and mechanical reliability, but this reduces the energy density to a certain extent.

In an implementation of this application, 6.49 mg/cm²≤W_{z}≤11.69 mg/cm². For example, W_{z} is 6.49 mg/cm², 6.7 mg/cm², 7 mg/cm², 7.23 mg/cm², 7.5 mg/cm², 7.79 mg/cm², 8 mg/cm², 8.24 mg/cm², 8.5 mg/cm², 8.8 mg/cm², 9 mg/cm², 9.2 mg/cm², 9.5 mg/cm², 9.7 mg/cm², 10 mg/cm², 10.2 mg/cm², 10.5 mg/cm², 10.7 mg/cm², 11 mg/cm², or 11.69 mg/cm², or any value in a range defined by any two of the above values. In this application, the coating weight of the positive electrode active material layer is adjusted to be within the range in this application, the transmission distance of lithium ions and electrons on the positive electrode sheet can be shortened, reducing the ohmic polarization and concentration polarization of the secondary battery, thereby reducing the impedance of the secondary battery and achieving good cycling kinetic performance of the secondary battery while ensuring processing reliability.

In an implementation of this application, 4.00 mg/cm²≤W_{f}≤5.19 mg/cm². For example, W_{f} is 4.00 mg/cm², 4.25 mg/cm², 4.5 mg/cm², 4.75 mg/cm², 5 mg/cm², or 5.19 mg/cm², or any value in a range defined by any two of the above values. Adjusting W_{f} to be within the above range optimizes the coating weight range of the negative electrode active material layer, further improving cycling kinetic performance of the secondary battery while ensuring processing reliability.

In an implementation of this application, 8.00 mg/cm²≤W_{z}≤10.38 mg/cm². For example, W_{z} is 8 mg/cm², 8.6 mg/cm², 9.1 mg/cm², 9.5 mg/cm², 10 mg/cm², or 10.38 mg/cm², or any value in a range defined by any two of the above values. Adjusting W_{z} to be within the above range optimizes the coating weight range of the positive electrode active material layer, further improving cycling kinetic performance of the secondary battery while ensuring processing reliability.

In an implementation of this application, 4 mg/cm²≤W_{f}≤5.19 mg/cm², and 8 mg/cm²≤W_{z}≤10.38 mg/cm². For example, W_{f} is 4 mg/cm², 4.25 mg/cm², 4.5 mg/cm², 4.75 mg/cm², 5 mg/cm², or 5.19 mg/cm², or any value in a range defined by any two of the above values. For example, W_{z} is 8 mg/cm², 8.5 mg/cm², 9 mg/cm², 9.5 mg/cm², or 10.38 mg/cm², or any value in a range defined by any two of the above values. Adjusting W_{z} and W_{f} to be within the above range optimizes the coating weight ranges of the positive electrode active material layer and the negative electrode active material layer, further improving cycling kinetic performance of the secondary battery while ensuring processing reliability.

In an implementation of this application, the Dᵥ99 of the positive electrode active material is 28 μm to 31 μm. For example, the Dᵥ99 of the positive electrode active material is 28 μm, 29 μm, 30 μm, or 31 μm, or any value in a range defined by any two of the above values. Adjusting the Dᵥ99 of the positive electrode active material to be within the above range optimizes the range of the Dᵥ99 of the positive electrode active material, further improving cycling kinetic performance and processing reliability of the secondary battery.

In an implementation of this application, the Dᵥ99 of the negative electrode active material is 24 μm to 26 μm. For example, the Dᵥ99 of the negative electrode active material is 24 μm, 25 μm, or 26 μm, or any value in a range defined by any two of the above values. Adjusting the Dᵥ99 of the negative electrode active material to be within the above range optimizes the range of the Dᵥ99 of the negative electrode active material, further improving cycling kinetic performance and processing reliability of the secondary battery.

In an implementation of this application, the Dᵥ99 of the positive electrode active material is 28 μm to 31 μm, and the Dᵥ99 of the negative electrode active material is 24 μm to 26 μm. For example, the Dᵥ99 of the positive electrode active material is 28 μm, 29 μm, 30 μm, or 31 μm, or any value in a range defined by any two of the above values. The Dᵥ99 of the negative electrode active material is 24 μm, 25 μm, or 26 μm, or any value in a range defined by any two of the above values. Adjusting the Dᵥ99 of the positive electrode active material and the negative electrode active material to be within the above ranges optimizes the ranges of the Dᵥ99 of the positive electrode active material and the negative electrode active material, further improving cycling kinetic performance and processing reliability of the secondary battery.

In an implementation of this application, the negative electrode active material includes at least one of a carbon-based material, a silicon-based material, or a tin-based material. The carbon-based material includes at least one of natural graphite, artificial graphite, soft carbon, hard carbon, or mesocarbon microbeads. The silicon-based material includes at least one of elemental silicon, silicon-carbon material, or silicon-oxygen material, and the tin-based material includes at least one of elemental tin, tin alloy, or tin oxide. The above types of negative electrode active material have high surface activity. When applied to the secondary battery, they can increase active sites for lithium ion deintercalation, reducing electrochemical polarization of the secondary battery, thereby reducing the impedance of the secondary battery, achieving good cycling kinetic performance of the secondary battery while ensuring processing reliability.

In an implementation of this application, the carbon-based material satisfies 0.1≤I_{d}/I_{g}≤1.0, where I_{d}/I_{g} is a peak intensity ratio of the d peak to the g peak measured through Raman test. For example, I_{d}/I_{g} is 0.1, 0.2, 0.3, 0.4, 0.5, 0.6, 0.7, 0.8, 0.9, or 1.0, or any value in a range defined by any two of the above values. This indicates that a surface of the carbon-based material contains amorphous carbon. The presence of amorphous carbon on the surface of the carbon-based material can enhance the electrochemical activity of the carbon-based material. In the cycling process of the secondary battery, the intercalation of lithium ions is smoother, reducing the electrochemical polarization of the secondary battery, thereby reducing the internal impedance of the secondary battery and improving cycling kinetic performance. Applying the carbon-based material satisfying the above I_{d}/I_{g} value to the secondary battery further improves cycling kinetic performance of the secondary battery while ensuring good processing reliability.

In this application, the d peak is a peak in the Raman spectrum of the carbon-based material particles with a shift range of 1300 cm⁻¹ to 1400 cm⁻¹, and the g peak is a peak in the Raman spectrum of the carbon-based material particles with a shift range of 1530 cm⁻¹ to 1630 cm⁻¹.

The adjustment method of the I_{d}/I_{g} value is not particularly limited in this application, as long as the objective of this application can be achieved. For example, commercially available carbon-based materials with different contents of amorphous carbon on a surface can be selected, and I_{d}/I_{g} of the carbon-based material may be determined through Raman (Raman) test in this application for selection of the carbon-based material with required I_{d}/I_{g}.

A preparation method of the carbon-based material is not particularly limited in this application, as long as the objective of this application can be achieved. For example, the preparation method of the carbon-based material may include but is not limited to: mixing the carbon-based material and amorphous carbon uniformly, heating the mixture to 500° C. to 1500° C., and holding the temperature for 10 h to 20 h to obtain a carbon-based material with amorphous carbon coated on a surface.

In an implementation of this application, the positive electrode active material includes at least one of lithium nickel cobalt manganese oxide, lithium nickel cobalt aluminum oxide, lithium iron phosphate, a lithium-rich manganese-based material, lithium cobalt oxide, lithium manganese oxide, lithium manganese iron phosphate, or lithium titanate. A chemical formula of the above “lithium-rich manganese-based material” is LiMnO·LiMO, where M may include Ni, Co, or Mn. The above types of positive electrode active materials have high surface activity. When applied to the secondary battery, they can increase active sites for lithium ion deintercalation, reducing the electrochemical polarization of the secondary battery, thereby reducing the impedance of the secondary battery, achieving good cycling kinetic performance of the secondary battery while ensuring processing reliability.

In an implementation of this application, the positive electrode active material further includes a non-metal element, and the non-metal element includes at least one of fluorine, phosphorus, boron, chlorine, silicon, or sulfur. A content of the non-metal element in the positive electrode active material is not particularly limited in this application, as long as the objective of this application can be achieved. In an implementation, based on a mass of the positive electrode active material, a mass percentage of the non-metal element is 0.1% to 10%. For example, the mass percentage of the non-metal element is 0.1%, 1%, 2%, 3%, 4%, 5%, 6%, 7%, 8%, 9%, or 10%, or any value in a range defined by any two of the above values. Including the above types of non-metal elements in the positive electrode active material can further improve the stability of the positive electrode active material.

In an implementation of this application, the positive electrode sheet includes a positive electrode current collector and a positive electrode active material layer provided on at least one surface of the positive electrode current collector. In some embodiments, the positive electrode active material layer is provided on one surface of the positive electrode current collector, and in other embodiments, the positive electrode active material layer is provided on two surfaces of the positive electrode current collector, where the above “surface” may be a part or all of the surface of the positive electrode current collector. A type of the positive electrode current collector is not particularly limited in this application, as long as the objective of this application can be achieved. For example, the positive electrode current collector may include but is not limited to aluminum foil or aluminum alloy foil. The positive electrode active material layer in this application includes the positive electrode active material described in the foregoing implementations. In this application, thicknesses of the positive electrode current collector and the positive electrode active material layer are not particularly limited in this application, as long as the objective of this application can be achieved. For example, the thickness of the positive electrode current collector is 5 μm to 20 μm, and further, the thickness of the positive electrode current collector may be 6 μm to 18 μm. The thickness of the positive electrode active material layer is 30 μm to 120 μm.

Optionally, the positive electrode active material layer may further include a positive electrode conductive agent and a positive electrode binder. Types of the positive electrode conductive agent and the positive electrode binder in the positive electrode active material layer are not particularly limited in this application, as long as the objective of this application can be achieved. A mass ratio of the positive electrode active material, the positive electrode conductive agent, and the positive electrode binder in the positive electrode active material layer is not particularly limited in this application. Those skilled in the art can make selections based on actual needs, as long as the objective of this application can be achieved. For example, the mass ratio of the positive electrode active material, the positive electrode conductive agent, and the positive electrode binder in the positive electrode active material layer is (95-98):(0.5-2.5):(1.5-3.4).

In an implementation of this application, the negative electrode sheet includes a negative electrode current collector and a negative electrode active material layer provided on at least one surface of the negative electrode current collector. In some embodiments, the negative electrode active material layer is provided on one surface of the negative electrode current collector, and in other embodiments, the negative electrode active material layer is provided on two surfaces of the negative electrode current collector, where the above “surface” may be a part or all of a surface of the negative electrode current collector. A type of the negative electrode current collector is not particularly limited in this application, as long as the objective of this application can be achieved. For example, the negative electrode current collector includes but is not limited to copper foil, copper alloy foil, nickel foil, titanium foil, foamed nickel, or foamed copper. The negative electrode active material layer in this application includes the negative electrode active material described in the foregoing implementations. In this application, thicknesses of the negative electrode current collector and the negative electrode active material layer are not particularly limited, as long as the objective of this application can be achieved. For example, the thickness of the negative electrode current collector is 6 μm to 10 μm, and the thickness of the negative electrode active material layer is 30 μm to 130 μm.

Optionally, the negative electrode active material layer may further include at least one of a negative electrode conductive agent, a stabilizer, or a negative electrode binder. Types of the negative electrode conductive agent, the stabilizer, and the negative electrode binder in the negative electrode active material layer are not particularly limited in this application, as long as the objective of this application can be achieved. A mass ratio of the negative electrode active material, the negative electrode conductive agent, the stabilizer, and the negative electrode binder in the negative electrode active material layer is not particularly limited in this application, as long as the objective of this application can be achieved. For example, the mass ratio of the negative electrode active material, the negative electrode conductive agent, the stabilizer, and the negative electrode binder in the negative electrode active material layer is (96-98):(0.5-2):(0-1.5):(1.0-1.9).

The separator is not particularly limited in this application, as long as the objective of this application can be achieved. For example, the separator includes at least one of polyethylene (PE), polypropylene (PP), polyethylene terephthalate (PET), polyimide (PI), or aramid. For example, polyethylene includes at least one selected from high-density polyethylene, low-density polyethylene, and ultra-high molecular weight polyethylene. The separator of this application may have a porous structure. A pore size of the porous structure of the separator is not particularly limited in this application, as long as the objective of this application can be achieved. For example, the pore size may be 0.01 μm to 1 μm. A thickness of the separator is not particularly limited in this application, as long as the objective of this application can be achieved, for example, the thickness of the separator may be 5 μm to 500 μm.

In an implementation of this application, the secondary battery further includes a housing, the electrode assembly and an electrolyte are accommodated in the housing, and the housing is not particularly limited in this application, which may be a housing well known in the art, as long as the objective of this application can be achieved. For example, the housing includes but is not limited to an aluminum-plastic film or a steel housing.

A type of the secondary battery is not particularly limited in this application, which may include any apparatus in which electrochemical reactions occur. For example, the secondary battery may include but is not limited to lithium metal secondary battery, lithium-ion secondary battery (lithium-ion battery), sodium-ion secondary battery (sodium-ion battery), lithium polymer secondary battery, or lithium-ion polymer secondary battery.

The secondary battery in this application can be used under ultra-fast charge condition, specifically, it may be used under a charge rate of 5 C to 15 C, for example, the charge rate of the secondary battery may be 5 C, 6 C, 7 C, 8 C, 9 C, 10 C, 11 C, 12 C, 13 C, 14 C, or 15 C, or any rate in a range defined by any two of the above rates.

A preparation method of the positive electrode sheet is not particularly limited in this application, as long as the objective of this application can be achieved. For example, the preparation method of the positive electrode sheet includes but is not limited to the following steps: (1) preparing a positive electrode slurry; (2) applying the positive electrode slurry on a surface of the positive electrode main body region of the positive electrode current collector, and after drying, forming a positive electrode active material layer on one surface of the positive electrode main body region of the positive electrode current collector; (3) applying the positive electrode slurry to another surface of the positive electrode main body region of the positive electrode current collector, and after drying, forming positive electrode active material layers on two surfaces of the positive electrode main body region of the positive electrode current collector; (4) after cold pressing, die-cutting the positive electrode tab region of the positive electrode current collector, so that the positive electrode current collector as a whole extends to form a plurality of positive electrode tabs, so as to obtain a positive electrode sheet through slitting. Contents and types of the components in the positive electrode slurry in the above step (1) are not particularly limited in this application, and those skilled in the art can make selections based on actual conditions, as long as the objective of this application can be achieved. A solid content of the positive electrode slurry in the above step (1) is not particularly limited in this application, as long as the objective of this application can be achieved. A drying time and temperature in the above steps (2) and (3) are not particularly limited in this application, as long as the objective of this application can be achieved. Processing parameters of cold pressing in the above step (4) are not particularly limited in this application, as long as the objective of this application can be achieved.

A preparation method of the negative electrode sheet is not particularly limited in this application, as long as the objective of this application can be achieved. For example, the preparation method of the negative electrode sheet includes but is not limited to the following steps: (1) preparing a negative electrode slurry; (2) applying the negative electrode slurry to one surface of the negative electrode main body region of the negative electrode current collector, and after drying, forming a negative electrode active material layer on one surface of the negative electrode main body region of the negative electrode current collector; (3) applying the negative electrode slurry to another surface of the negative electrode main body region of the negative electrode current collector, and after drying, forming negative electrode active material layers on two surfaces of the negative electrode main body region of the negative electrode current collector; (4) after cold pressing, die-cutting the negative electrode tab region of the negative electrode current collector, so that the negative electrode current collector as a whole extends to form a plurality of negative electrode tabs, so as to obtain the negative electrode sheet through slitting. Contents and types of the components in the negative electrode slurry in the above step (1) are not particularly limited in this application, and those skilled in the art can make selections based on actual conditions, as long as the objective of this application can be achieved. A solid content of the negative electrode slurry in the above step (1) is not particularly limited in this application, as long as the objective of this application can be achieved. A drying time and temperature in the above steps (2) and (3) are not particularly limited in this application, as long as the objective of this application can be achieved. Processing parameters of cold pressing in the above step (4) are not particularly limited in this application, as long as the objective of this application can be achieved.

A preparation method of the secondary battery is not particularly limited in this application, and a preparation method well known in the art may be used, as long as the objective of this application can be achieved. For example, the preparation method of the secondary battery includes but is not limited to the following steps: stacking the separator, the positive electrode sheet, the separator, and the negative electrode sheet in sequence; performing operations such as winding or folding as needed to obtain a wound electrode assembly; placing the electrode assembly into a housing; injecting an electrolyte into the housing and performing sealing, to obtain the secondary battery. Alternatively, the separator, the positive electrode sheet, the separator, and the negative electrode sheet are stacked in sequence; four corners of the entire stacked structure are fixed to obtain a stacked electrode assembly; the electrode assembly is placed into a housing; and the electrolyte is injected into the housing and sealing is performed, to obtain the secondary battery.

In a second aspect of this application, an electric apparatus is provided, which includes the secondary battery described in any one of the foregoing implementations. Therefore, the electric apparatus exhibits good use performance.

The electric apparatus of this application is not particularly limited, and may be any electric apparatus known in the prior art. For example, the electric apparatus may include but is not limited to: notebook computer, pen-input computer, mobile computer, e-book player, portable phone, portable facsimile machine, portable copier, portable printer, head-mounted stereo headphone, video recorder, liquid crystal television, portable cleaner, portable CD player, mini disc, transceiver, electronic organizer, calculator, memory card, portable recorder, radio, backup power supply, motor, automobile, motorcycle, electric bicycle, bicycle, lighting fixture, toy, game console, clock, electric tool, flashlight, camera, household large-scale storage battery, and lithium-ion capacitor.

### EXAMPLES

Hereinafter, examples and comparative examples are given to more specifically illustrate these embodiments of this application. Various tests and evaluations were conducted according to the following methods.

### Test Methods and Devices

### Test for Dᵥ99

A laser particle size analyzer was used to measure the Dᵥ99 of the positive electrode active material and the negative electrode active material.

### Test for Coating Weight

### (1) Test for Coating Weight W_{z} of Positive Electrode Active Material Layer

A lithium-ion battery was discharged at 0.5 C to 3.0V and then disassembled to obtain a positive electrode sheet. The positive electrode sheet was soaked in a dimethyl carbonate (DMC) solution for 4 h, dried, and cut into a positive electrode sheet sample with an area of A mm². The sample was weighed on a balance and a weight was recorded as p₁; and after the positive electrode active material layer on the positive electrode sheet was washed off, the positive electrode current collector was weighed on a balance and a weight was recorded as p₂.

If one side of the positive electrode sheet is coated with the positive electrode active material layer, W_{z}=(p₁−p₂)/A.

If two sides of the positive electrode sheet are coated with the positive electrode active material layer, W_{z}=(p₁−p₂)/2A.

### (2) Test for Coating Weight W_{f} of Negative Electrode Active Material Layer

A lithium-ion battery was discharged at 0.5 C to 3.0V and then disassembled to obtain a negative electrode sheet. The negative electrode sheet was soaked in a DMC solution for 4 h, dried, and cut into a negative electrode sheet sample with an area of B mm². The sample was weighed on a balance and a weight was recorded as q₁; and after the negative electrode active material layer on the negative electrode sheet was washed off, the negative electrode current collector was weighed on a balance and a weight was recorded as q₂.

If one side of the negative electrode sheet is coated with the negative electrode active material layer, W_{f}=(q₁−q₂)/B.

If two sides of the negative electrode sheet are coated with the negative electrode active material layer, W_{f}=(q₁−q₂)/2B.

### Raman (Raman) Test

A lithium-ion battery was discharged at 0.5 C to 3.0V and then disassembled to obtain a negative electrode sheet. The negative electrode sheet was soaked in a DMC solution for 4 h and dried. An area of 100 μm×100 μm was selected on the negative electrode active material layer, and a laser confocal microscopic Raman spectrometer (Raman, HR Evolution, HORIBA Scientific) was used to scan the negative electrode active material particles in this area to obtain the d peaks and g peaks of all negative electrode active material particles in this area. LabSpec software was used to process the data to obtain the peak intensities of the d peak and g peak of each negative electrode active material particle, which were I_{d} and I_{g} respectively. The laser wavelength of the Raman spectrometer was in the range of 532 nm to 785 nm. The value of I_{d}/I_{g} was an average of ratios between I_{d} and I_{g} of all negative electrode active material particles measured in this range.

### Test for Cycling Kinetic Performance

The lithium-ion batteries in the examples and comparative examples were tested for cycling kinetic performance under a charge rate of 10 C. Specific steps are as follows.

(I): A test temperature was adjusted to a constant temperature of 25° C., and a sensor wire of a multipoint temperature tester was placed at the center of a surface of the lithium-ion battery, and the following steps were performed: (1) charge at a constant current of 10 C to 4.1V; (2) charge at a constant current of 7 C to 4.3V; (3) charge at a constant current of 6 C to 4.4V; (4) charge at a constant voltage of 4.4V to 0.05 C; (5) standing for 30 min; (6) discharge at a constant current 1 C to 3.0V; and (7) standing for 30 min. The procedure completed.

Charge speed: a time from step (1) to step (4) in step (I).

Charge temperature rise: a difference between a room temperature and the maximum temperature recorded by the sensor wire on the surface of the lithium-ion battery from step (1) to step (4) in step (I).

(II): A test temperature was adjusted to a constant temperature of 25° C., and the test was started: (1) charge at constant current of 10 C to 4.2V; (2) charge at a constant current of 8 C to 4.3V; (3) charge at a constant current of 6 C to 4.45V; (4) charge at a constant voltage 4.45V to 0.05 C; (5) standing for 5 min; (6) discharge at a constant current of 1 C to 3.0V; (7) standing for 5 min; (8) cycling steps (1) to (7) for 1000 cycles (cls). The procedure completed.

$$Capacity retention rate ( \% ) = discharge capacity after 1000 cls / first cycle discharge capacity \times 100 \% .$$

Cycling kinetic performance was characterized by the charge speed, charge temperature rise, and capacity retention rate, where a shorter charge time and a smaller charge temperature rise indicate better initial kinetic performance of the lithium-ion battery, and a higher capacity retention rate indicates better cycling performance of the lithium-ion battery.

### Test for Processing Reliability

### (1) Test for Breakage Frequency P_{f} of Negative Electrode Sheet

For the negative electrode sheet in each example and comparative example, the number of breakages in any 1000 m of the negative electrode sheet during cold pressing (before die-cutting or tab welding) at 60 t pressure per 100000 m was recorded.

### (2) Test for Breakage Frequency P_{z} of Positive Electrode Sheet

For the positive electrode sheet in each example and comparative example, the number of breakages in any 1000 m of the positive electrode sheet during cold pressing (before die-cutting or tab welding) at 60 t pressure per 100000 m was recorded.

### Example 1-1

### <Preparation of Negative Electrode Sheet>

A negative electrode active material, a negative electrode conductive agent superconductive carbon (Super P), a stabilizer carboxymethyl cellulose sodium (CMC-Na, where Mw=7×10⁵), and a negative electrode binder styrene-butadiene rubber (SBR, where Mw=7×10⁶) were mixed in a mass ratio of 96.5:1.0:1.0:1.5. Then deionized water was added as a solvent. The mixture was stirred by a vacuum mixer to obtain a uniform negative electrode slurry with a solid content of 58 wt %. The negative electrode slurry was uniformly applied to a negative electrode main body region on one surface of a negative electrode current collector copper foil with a thickness of 10 μm, and dried at 85° C. to obtain a negative electrode sheet with one side coated with a negative electrode active material layer. Then the above steps were repeated on a negative electrode main body region on another surface of the copper foil to obtain a negative electrode sheet with two sides coated with a negative electrode active material layer. After cold pressing, die-cutting was performed in a negative electrode tab region of the negative electrode current collector to form negative electrode tabs, and then slitting was performed. After slitting, drying was performed at 110° C. for 4 h under vacuum to obtain a negative electrode sheet with a specification of 55 mm×1300 mm for later use. A single-layer thickness of the negative electrode active material layer was 58.5 μm, and a thickness of the negative electrode sheet was 127 μm. The negative electrode tab region of the negative electrode current collector as a whole extended (structure was shown in FIG. 4, but not limited to that in FIG. 4) to form 32 negative electrode tabs. A compacted density of the negative electrode sheet was 1.5 g/cm³. Dᵥ99 of the negative electrode active material was 25 μm. A coating weight W_{f} of the negative electrode active material layer was 5.19 mg/cm². A type of the negative electrode active material was shown in Table 2.

### <Preparation of Positive Electrode Sheet>

A positive electrode active material lithium cobalt oxide, a positive electrode conductive agent Super P, and a positive electrode binder polyvinylidene fluoride (PVDF, where Mw=7×10⁶) were mixed in a mass ratio of 96:2:2. N-methylpyrrolidone (NMP) was added as a solvent. The mixture was stirred by a vacuum mixer to obtain a uniform positive electrode slurry with a solid content of 75 wt %. The positive electrode slurry was uniformly applied to a positive electrode main body region on one surface of a positive electrode current collector aluminum foil with a thickness of 13 μm, and dried at 95° C. to obtain a positive electrode sheet with one side coated with a positive electrode active material layer. Then, the above steps were repeated on a positive electrode main body region on another surface of the aluminum foil to obtain a positive electrode sheet with two sides coated with a positive electrode active material layer. After cold pressing, die-cutting was performed in a positive electrode tab region of the positive electrode current collector to form positive electrode tabs, and then slitting was performed. After slitting, drying was performed at 85° C. for 4 h under vacuum to obtain a positive electrode sheet with a specification of 51 mm×1200 mm for later use. A single-layer thickness of the positive electrode active material layer was 38.5 μm, and a thickness of the positive electrode sheet was 90 μm. The positive electrode tab region of the positive electrode current collector as a whole extended (structure was shown in FIG. 3, but not limited to that in FIG. 3) to form 32 positive electrode tabs. A compacted density of the positive electrode sheet was 4.0 g/cm³. Dᵥ99 of lithium cobalt oxide was 30 μm. A coating weight W_{z} of the positive electrode active material layer was 10.38 mg/cm².

### <Preparation of Electrolyte>

In an environment with a water content of less than 10 ppm, n-propyl propionate, ethylene carbonate, and diethyl carbonate were mixed in a mass ratio of 34:33:33 as a solvent. A lithium salt lithium hexafluorophosphate (LiPF₆), the solvent, and an additive adiponitrile were formulated in a mass ratio of 15:83:2 to obtain an electrolyte.

### <Preparation of Separator>

A porous polyethylene film with a thickness of 15 μm was used as the separator.

### <Preparation of Lithium-Ion Battery>

The separator, positive electrode sheet, separator, and negative electrode sheet were stacked in sequence so that the separator was sandwiched between the positive electrode sheet and the negative electrode sheet for separation, and were wound to obtain an electrode assembly. The positive electrode tab was led out through spot welding an aluminum tab, and the negative electrode tab was led out through spot welding a nickel tab. After winding, in the wound electrode assembly, N₁=0 layers of positive electrode sheets were provided between two adjacent positive electrode tabs, and N₂=0 layers of negative electrode sheets were provided between two adjacent negative electrode tabs. Each layer of positive electrode sheet provided with a positive electrode tab had one positive electrode tab, and each layer of negative electrode sheet provided with a negative electrode tab had one negative electrode tab (the setting of positive and negative electrode tabs was as shown in FIG. 1, but not limited to that in FIG. 1).

The electrode assembly was placed in an aluminum-plastic film housing. After drying, the electrolyte was injected. Processes such as vacuum packaging, standing, formation, capacity testing, degassing, and trimming were performed to obtain a lithium-ion battery.

### Example 1-2

### <Preparation of Positive Electrode Sheet>

Except that the positive electrode tab region of the positive electrode current collector as a whole extended to form 16 positive electrode tabs, this example was the same as Example 1-1.

### <Preparation of Negative Electrode Sheet>

Except that the negative electrode tab region of the negative electrode current collector as a whole extended to form 16 negative electrode tabs, this example was the same as Example 1-1.

### <Preparation of Lithium-Ion Battery>

Except that N₁=1 layer of positive electrode sheet was provided between two adjacent positive electrode tabs, and N₂=1 layer of negative electrode sheet was provided between two adjacent negative electrode tabs, this example was the same as Example 1-1.

<Preparation of separator> and <Preparation of electrolyte> were the same as those in Example 1-1.

### Example 1-3

### <Preparation of Positive Electrode Sheet>

Except that the positive electrode tab region of the positive electrode current collector as a whole extended to form 10 positive electrode tabs, this example was the same as Example 1-1.

### <Preparation of Negative Electrode Sheet>

Except that the negative electrode tab region of the negative electrode current collector as a whole extended to form 10 negative electrode tabs, this example was the same as Example 1-1.

### <Preparation of Lithium-Ion Battery>

Except that N₁=2 layers of positive electrode sheets were provided between two adjacent positive electrode tabs, and N₂=2 layers of negative electrode sheets were provided between two adjacent negative electrode tabs, this example was the same as Example 1-1.

<Preparation of separator> and <Preparation of electrolyte> were the same as those in Example 1-1.

### Examples 1-4 to 1-19

Except that the relevant preparation parameters were adjusted according to Table 1, these examples were the same as Example 1-1.

### Example 2-1

Except that the relevant preparation parameters were adjusted according to Table 2, this example was the same as Example 1-1.

### Examples 2-2 to 2-4

Except that artificial graphite with amorphous carbon coated on a surface was used as the negative electrode active material in <Preparation of negative electrode sheet>, these examples were the same as Example 1-1. The mass ratio of artificial graphite to amorphous carbon was adjusted according to Table 3.

### Examples 2-5 and 2-6

Except that the relevant preparation parameters were adjusted according to Table 2, both examples were the same as Example 1-1.

### Comparative Example 1

### <Preparation of Negative Electrode Sheet>

A negative electrode active material, a negative electrode conductive agent Super P, a stabilizer carboxymethyl cellulose sodium (CMC-Na, where Mw=7×10⁵), and a negative electrode binder styrene-butadiene rubber (SBR, where Mw=7×10⁶) were mixed in a mass ratio of 96.5:1.0:1.0:1.5. The deionized water was added as a solvent. The mixture was stirred by a vacuum mixer to obtain a uniform negative electrode slurry with a solid content of 58 wt %. The negative electrode slurry was uniformly applied to a surface of a negative electrode current collector copper foil with a thickness of 10 μm, and dried at 85° C. to obtain a negative electrode sheet with one side coated with a negative electrode active material layer. Then the above steps were repeated on another surface of the copper foil to obtain a negative electrode sheet with two sides coated with a negative electrode active material layer. Then cold pressing, cutting, and slitting were performed. After slitting, drying was performed at 110° C. for 4 h under vacuum, and a negative electrode tab nickel tab was welded on a surface of the negative electrode current collector to obtain a negative electrode sheet with a specification of 55 mm×1300 mm for later use. A single-layer thickness of the negative electrode active material layer was 58.5 μm, and a thickness of the negative electrode sheet was 127 μm. A compacted density of the negative electrode sheet was 1.5 g/cm³. Dᵥ99 of the negative electrode active material was 25 μm. A coating weight W_{f} of the negative electrode active material layer was 5.19 mg/cm². A type of the negative electrode active material was the same as in that in Example 1-1.

### <Preparation of Positive Electrode Sheet>

A positive electrode active material lithium cobalt oxide, a positive electrode conductive agent Super P, and a positive electrode binder polyvinylidene fluoride (PVDF, where Mw=70×10⁵) were mixed in a mass ratio of 96:2:2. N-methylpyrrolidone (NMP) was added as a solvent. The mixture was stirred by a vacuum mixer to obtain a uniform positive electrode slurry with a solid content of 75 wt %. The positive electrode slurry was uniformly applied to one surface of a positive electrode current collector aluminum foil with a thickness of 13 μm, and dried at 95° C. to obtain a positive electrode sheet with one side coated with a positive electrode active material layer. Then the above steps were repeated on another surface of the aluminum foil to obtain a positive electrode sheet with two sides coated with a positive electrode active material layer. Then cold pressing, cutting, and slitting were performed. After slitting, drying was performed at 85° C. for 4 h under vacuum, and a positive electrode tab aluminum tab was welded on a surface of the positive electrode current collector to obtain a positive electrode sheet with a specification of 51 mm×1200 mm for later use. A single-layer thickness of the positive electrode active material layer was 38.5 μm, and a thickness of the positive electrode sheet was 90 μm. A compacted density of the positive electrode sheet was 4.0 g/cm³. Dᵥ99 of lithium cobalt oxide was 30 μm. A coating weight W_{z} of the positive electrode active material layer was 10.38 mg/cm².

### <Preparation of Lithium-Ion Battery>

A positive electrode sheet, a separator, and a negative electrode sheet were stacked in sequence so that the separator was sandwiched between the positive electrode sheet and the negative electrode sheet for separation, and were wound to obtain an electrode assembly. The electrode assembly was placed in an aluminum-plastic film housing. After drying, the electrolyte was injected. Processes such as vacuum packaging, standing, formation, capacity testing, degassing, and trimming were performed to obtain a lithium-ion battery.

<Preparation of separator> and <Preparation of electrolyte> were the same as those in Example 1-1.

### Comparative Examples 2 to 9

Except that the relevant preparation parameters were adjusted according to Table 1, these examples were the same as those in Example 1-1.

### Comparative Examples 10 to 15

In <Preparation of positive electrode sheet> and <Preparation of negative electrode sheet>, except that the relevant preparation parameters were adjusted according to Table 1, these examples were the same as those in Comparative example 1.

<Preparation of separator>, <Preparation of electrolyte> and <Preparation of lithium-ion battery> were the same as in those in Comparative example 1.

### Comparative Examples 16 and 17

Except that the relevant preparation parameters were adjusted according to Table 1, both comparative examples were the same as Example 1-1.

The preparation parameters and performance parameters in the examples and comparative examples were shown in Table 1 and Table 2.

TABLE 1

| | | | | | | | | Breakage | Breakage | | | |
|---|---|---|---|---|---|---|---|---|---|---|---|---|
| | | | Dᵥ99 of | Dᵥ99 of | | | | frequency | frequency | | | |
| | | | negative | positive | | | | of negative | of positive | | | |
| | | | electrode | electrode | | | | electrode | electrode | 10 C | | |
| | | | active | active | W_{f} | | W_{z} | sheet | sheet | charge | 10 C charge | Capacity |
| | | | material | material | (mg/ | W_{z}/ | (mg/ | (times/ | (times/ | speed | temperature | retention |
| | N₁ | N₂ | (μm) | (μm) | cm²) | W_{f} | cm²) | 1000 m) | 1000 m) | (min) | rise (° C.) | rate (%) |
| Example 1-1 | 0 | 0 | 25 | 30 | 5.19 | 2.0 | 10.38 | 0.40 | 0.63 | 15.4 | 18.5 | 85.2 |
| Example 1-2 | 1 | 1 | 25 | 30 | 5.19 | 2.0 | 10.38 | 0.41 | 0.65 | 16.7 | 19.6 | 82.1 |
| Example 1-3 | 2 | 2 | 25 | 30 | 5.19 | 2.0 | 10.38 | 0.40 | 0.64 | 16.8 | 20.2 | 81.4 |
| Example 1-4 | 0 | 0 | 25 | 30 | 3.25 | 2.0 | 6.50 | 1.82 | 3.76 | 12.2 | 15.5 | 87.6 |
| Example 1-5 | 0 | 0 | 25 | 30 | 3.60 | 2.0 | 7.20 | 1.11 | 1.88 | 13.4 | 16.8 | 86.2 |
| Example 1-6 | 0 | 0 | 25 | 30 | 4.01 | 2.0 | 8.02 | 0.62 | 1.1 | 13.9 | 17.1 | 85.8 |
| Example 1-7 | 0 | 0 | 25 | 30 | 4.60 | 2.0 | 9.20 | 0.54 | 0.75 | 14.5 | 17.6 | 85.6 |
| Example 1-8 | 0 | 0 | 25 | 30 | 5.00 | 2.0 | 10.00 | 0.45 | 0.69 | 15.2 | 18.6 | 85.3 |
| Example 1-9 | 0 | 0 | 25 | 30 | 5.84 | 2.0 | 11.68 | 0.20 | 0.52 | 16.9 | 19.8 | 80.2 |
| Example 1-10 | 0 | 0 | 25 | 30 | 5.19 | 1.6 | 8.30 | 0.42 | 1.0 | 15.0 | 18.0 | 71.4 |
| Example 1-11 | 0 | 0 | 25 | 30 | 5.19 | 2.2 | 11.42 | 0.41 | 0.42 | 16.4 | 19.6 | 70.3 |
| Example 1-12 | 0 | 0 | 23 | 30 | 5.19 | 2.0 | 10.38 | 0.33 | 0.64 | 15.2 | 18.6 | 79.6 |
| Example 1-13 | 0 | 0 | 24 | 30 | 5.19 | 2.0 | 10.38 | 0.37 | 0.64 | 15.3 | 18.8 | 82.4 |
| Example 1-14 | 0 | 0 | 26 | 30 | 5.19 | 2.0 | 10.38 | 0.43 | 0.67 | 15.4 | 18.8 | 83.8 |
| Example 1-15 | 0 | 0 | 28 | 30 | 5.19 | 2.0 | 10.38 | 0.56 | 0.62 | 16.5 | 19.3 | 80.2 |
| Example 1-16 | 0 | 0 | 25 | 27 | 5.19 | 2.0 | 10.38 | 0.40 | 0.44 | 15.1 | 18.5 | 78.5 |
| Example 1-17 | 0 | 0 | 25 | 28 | 5.19 | 2.0 | 10.38 | 0.43 | 0.57 | 15.2 | 18.6 | 83.4 |
| Example 1-18 | 0 | 0 | 25 | 31 | 5.19 | 2.0 | 10.38 | 0.44 | 0.74 | 15.4 | 18.8 | 83.2 |
| Example 1-19 | 0 | 0 | 25 | 33 | 5.19 | 2.0 | 10.38 | 0.47 | 0.83 | 16.7 | 19.3 | 75.4 |
| Comparative | \ | \ | 25 | 30 | 5.19 | 2.0 | 10.38 | 0.21 | 0.43 | 19.8 | 22.5 | 60.3 |
| example 1 | | | | | | | | | | | | |
| Comparative | 0 | 0 | 25 | 30 | 2.50 | 2.0 | 5.00 | 2.44 | 4.66 | 12.0 | 15.3 | 86.6 |
| example 2 | | | | | | | | | | | | |
| Comparative | 0 | 0 | 25 | 30 | 7.79 | 2.0 | 15.58 | 0.12 | 0.34 | 19.4 | 25.8 | 55.2 |
| example 3 | | | | | | | | | | | | |
| Comparative | 0 | 0 | 25 | 30 | 5.19 | 1.4 | 7.27 | 0.42 | 1.76 | 15.5 | 19.0 | 55.4 |
| example 4 | | | | | | | | | | | | |
| Comparative | 0 | 0 | 25 | 30 | 5.19 | 2.4 | 12.46 | 0.43 | 0.31 | 15.3 | 22.4 | 35.2 |
| example 5 | | | | | | | | | | | | |
| Comparative | 0 | 0 | 20 | 30 | 5.19\| | 2.0 | 10.38 | 0.26 | 0.63 | 15.1 | 18.4 | 60.6 |
| example 6 | | | | | | | | | | | | |
| Comparative | 0 | 0 | 30 | 30 | 5.19 | 2.0 | 10.38 | 0.61 | 0.62 | 17.7 | 20.0 | 62.4 |
| example 7 | | | | | | | | | | | | |
| Comparative | 0 | 0 | 25 | 25 | 5.19 | 2.0 | 10.38 | 0.43 | 0.34 | 16.2 | 18.5 | 53.3 |
| example 8 | | | | | | | | | | | | |
| Comparative | 0 | 0 | 25 | 38 | 5.19 | 2.0 | 10.38 | 0.45 | 1.24 | 18.6 | 21.0 | 64.2 |
| example 9 | | | | | | | | | | | | |
| Comparative | \ | \ | 20 | 25 | 5.19 | 2.0 | 10.38 | 0.11 | 0.37 | 18.6 | 21.2 | 45.3 |
| example 10 | | | | | | | | | | | | |
| Comparative | \ | \ | 30 | 38 | 5.19 | 2.0 | 10.38 | 0.32 | 0.53 | 21.0 | 23.8 | 40.2 |
| example 11 | | | | | | | | | | | | |
| Comparative | \ | \ | 20 | 25 | 2.50\| | 2.0 | 5.00 | 0.11 | 0.34 | 17.8 | 20.5 | 34.3 |
| example 12 | | | | | | | | | | | | |
| Comparative | \ | \ | 30 | 38 | 7.79 | 2.0 | 15.58 | 0.36 | 0.59 | 21.4 | 24.3 | 38.1 |
| example 13 | | | | | | | | | | | | |
| Comparative | \ | \ | 20 | 25 | 2.50 | 1.4 | 3.50 | 0.113 | 0.35 | 17.1 | 20.8 | 30.4 |
| example 14 | | | | | | | | | | | | |
| Comparative | \ | \ | 30 | 38 | 7.79 | 2.4 | 18.70 | 0.37 | 0.52 | 21.6 | 24.7 | 28.3 |
| example 15 | | | | | | | | | | | | |
| Comparative | 0 | 0 | 20 | 25 | 2.50 | 2.0 | 5.00 | 1.67 | 3.26 | 11.9 | 15.2 | 58.6 |
| example 16 | | | | | | | | | | | | |
| Comparative | 0 | 0 | 30 | 38 | 7.79 | 2.0 | 15.58 | 0.65 | 1.06 | 20.6 | 26.1 | 47.2 |
| example 17 | | | | | | | | | | | | |

Note:
The character “\” in Table 1 indicates no corresponding parameter.

From Examples 1-1 to 1-19 and Comparative examples 1 to 17, it can be learned that for the secondary batteries in the examples of this application, the value of W_{f} and the ratio W_{z}/W_{f} of the coating weight W_{z} of the positive electrode active material layer to the coating weight W_{f} of the negative electrode active material layer are set to be within the ranges in this application, the Dᵥ99 of the positive electrode active material and the Dᵥ99 of the negative electrode active material are set to be within the ranges of this application, and the positive electrode current collector as a whole extends to form a plurality of positive electrode tabs and the negative electrode current collector as a whole extends to form a plurality of negative electrode tabs to form a multi-tab structure. In this case, for the secondary battery, the charge time is shorter (that is, a charge speed is higher), the charge temperature rise is lowered, and a capacity retention rate is higher at the charge rate of 10 C, indicating that the secondary battery has better cycling kinetic performance under an ultra-fast charge condition; and the positive electrode sheet and negative electrode sheet have lower breakage frequencies, indicating that the secondary battery has good processing reliability. In this way, the secondary batteries in the examples in this application exhibit processing reliability while having good cycling kinetic performance under the ultra-fast charge condition. The secondary battery in Comparative example 1 has an embedded single-tab structure rather than the multi-tab structure in this application. In the secondary batteries in Comparative examples 2 and 3, the negative electrode active material layer has the coating weight W_{f} not within the range in this application. In the secondary batteries in Comparative examples 4 and 5, the ratio W_{z}/W_{f} of the coating weight W_{z} of the positive electrode active material layer to the coating weight W_{f} of the negative electrode active material layer is not within the range in this application. In the secondary batteries in Comparative examples 6 and 7, the Dᵥ99 of the negative electrode active material is not within the range in this application. In the secondary batteries in Comparative examples 8 and 9, the Dᵥ99 of the positive electrode active material is not within the range in this application. The secondary batteries in Comparative examples 10 and 11 have an embedded single-tab structure rather than the multi-tab structure in this application, and the Dᵥ99 of the negative electrode active material and the Dᵥ99 of the positive electrode active material are not within the ranges in this application. The secondary batteries in Comparative examples 12 and 13 have an embedded single-tab structure rather than the multi-tab structure in this application; and none of the value of W_{f}, the Dᵥ99 of the positive electrode active material, and the Dᵥ99 of the negative electrode active material is within the range in this application. The secondary batteries in Comparative examples 14 and 15 have an embedded single-tab structure rather than the multi-tab structure in this application; and none of the value of W_{f}, the Dᵥ99 of the positive electrode active material, the Dᵥ99 of the negative electrode active material, and the ratio W_{z}/W_{f} of the coating weight W_{z} of the positive electrode active material layer to the coating weight W_{f} of the negative electrode active material layer is within the range in this application. In the secondary batteries in Comparative examples 16 and 17, none of the value of W_{f}, the Dᵥ99 of the positive electrode active material, the Dᵥ99 of the negative electrode active material is within the range in this application. In the secondary batteries in Comparative examples 1 to 17, for the secondary batteries, the charge time is longer (that is, a charge speed is lower) and/or the charge temperature rise is higher and/or the capacity retention rate is lower at the charge rate of 10 C, or the positive electrode sheet and/or negative electrode sheet have/has a higher breakage frequency, indicating that the charge speed, the charge temperature rise, cycling performance, and processing performance of the secondary batteries cannot be balanced under the ultra-fast charge condition.

The values of N₁ and N₂ usually affect the cycling kinetics and processing reliability of the secondary battery. From Examples 1-1 to 1-3, it can be learned that overall, for the secondary batteries with the values of N₁ and N₂ within the ranges in this application, the charge time is shorter (that is, the charge speed is higher), the charge temperature rise is lower, and the capacity retention rate is higher at the charge rate of 10 C, and the positive electrode sheet and negative electrode sheet have lower breakage frequencies, indicating that good cycling kinetic performance of the secondary batteries can be achieved under the ultra-fast charge condition while processing reliability is ensured.

The coating weight W_{f} of the negative electrode active material layer usually affects cycling kinetics and processing reliability of the secondary battery. From Example 1-1, Examples 1-4 to 1-9, Comparative example 2, and Comparative example 3, it can be learned that overall, for the secondary batteries whose negative electrode active material layer has the coating weight W_{f} within the range in this application, the charge time is shorter, the charge temperature rise is lower, and the capacity retention rate is higher at the charge rate of 10 C, and the positive electrode sheet and negative electrode sheet have lower breakage frequencies, indicating that good cycling kinetic performance of the secondary batteries can be achieved under the ultra-fast charge condition while processing reliability is ensured.

The ratio W_{z}/W_{f} of the coating weight W_{z} of the positive electrode active material layer to the coating weight W_{f} of the negative electrode active material layer usually affects cycling kinetics and processing reliability of the secondary battery. From Example 1-1, Example 1-10, Example 1-11, Comparative example 4, and Comparative example 5, it can be learned that overall, for the secondary batteries whose ratio W_{z}/W_{f} of the coating weight W_{z} of the positive electrode active material layer to the coating weight W_{f} of the negative electrode active material layer is within the range in this application, the charge time is shorter, the charge temperature rise is lower, and the capacity retention rate is higher at the charge rate of 10 C, and the positive electrode sheet and negative electrode sheet have lower breakage frequencies, indicating that good cycling kinetic performance of the secondary batteries can be achieved under the ultra-fast charge condition while processing reliability is ensured.

The Dᵥ99 of the negative electrode active material usually affects cycling kinetics and processing reliability of the secondary battery. From Example 1-1, Examples 1-12 to 1-15, Comparative example 6, and Comparative example 7, it can be learned that overall, for the secondary batteries whose negative electrode active material has the Dᵥ99 within the range in this application, the charge time is shorter, the charge temperature rise is lower, and the capacity retention rate is higher at the charge rate of 10 C, and the positive electrode sheet and negative electrode sheet have lower breakage frequencies, indicating that good cycling kinetic performance of the secondary batteries can be achieved under the ultra-fast charge condition while processing reliability is ensured.

The Dᵥ99 of the positive electrode active material usually affects cycling kinetics and processing reliability of the secondary battery. From Example 1-1, Examples 1-16 to 1-19, Comparative example 8, and Comparative example 9, it can be learned that overall, for the secondary batteries whose positive electrode active material has the Dᵥ99 within the range in this application, the charge time is shorter, the charge temperature rise is lower, and the capacity retention rate is higher at the charge rate of 10 C, and the positive electrode sheet and negative electrode sheet have lower breakage frequencies, indicating that good cycling kinetic performance of the secondary batteries can be achieved under the ultra-fast charge condition while processing reliability is ensured.

TABLE 2

| | | | | Breakage | Breakage | | | |
|---|---|---|---|---|---|---|---|---|
| | | | | frequency | frequency | | | |
| | | | | of negative | of positive | | | |
| | | | Positive | electrode | electrode | 10 C | | |
| | | | electrode | sheet | sheet | charge | 10 C charge | Capacity |
| | Negative electrode | | active | (times/ | (times/ | speed | temperature | retention |
| | active material | I_{d}/I_{g} | material | 1000 m) | 1000 m) | (min) | rise (° C.) | rate (%) |
| Example | Artificial graphite + amorphous | 0.8 | Lithium | 0.40 | 0.63 | 15.4 | 18.5 | 85.2 |
| 1-1 | carbon (Mr = 92:8) | | cobalt | | | | | |
| | | | oxide | | | | | |
| Example | material (mass ratio | 0 | Lithium | 0.51 | 0.64 | 16.8 | 19.7 | 80.1 |
| 2-1 | Silicon-carbon of silicon to carbon | | cobalt | | | | | |
| | 5:95) | | oxide | | | | | |
| Example | Artificial graphite + amorphous | 0.2 | Lithium | 0.55 | 0.63 | 15.8 | 19.3 | 81.2 |
| 2-2 | carbon (Mr = 98:2) | | cobalt | | | | | |
| | | | oxide | | | | | |
| Example | Artificial graphite + amorphous | 0.5 | Lithium | 0.53 | 0.62 | 15.5 | 19.0 | 83.2 |
| 2-3 | carbon (Mr = 95:5) | | cobalt | | | | | |
| | | | oxide | | | | | |
| Example | Artificial graphite + amorphous | 1.0 | Lithium | 0.51 | 0.66 | 15.2 | 18.5 | 82.1 |
| 2-4 | carbon (Mr = 90:10) | | cobalt | | | | | |
| | | | oxide | | | | | |
| Example | Artificial graphite + amorphous | 0.8 | Lithium | 0.46 | 0.73 | 15.5 | 18.8 | 83.1 |
| 2-5 | carbon (Mr = 92:8) | | iron | | | | | |
| | | | phosphate | | | | | |
| Example | Artificial graphite + amorphous | 0.8 | Lithium | 0.41 | 1.73 | 15.4 | 18.9 | 82.3 |
| 2-6 | carbon (Mr = 92:8) | | nickel | | | | | |
| | | | cobalt | | | | | |
| | | | manganese | | | | | |
| | | | oxide | | | | | |
| | | | (NCM811) | | | | | |

Note:
The character “\” in Table 2 indicates no corresponding parameter; and “Mr” in Table 2 indicates the mass ratio of artificial graphite to amorphous carbon.

The type of the negative electrode active material and the I_{d}/I_{g} value of the carbon-based material usually affect cycling kinetic performance and processing reliability of the secondary battery. From Example 1-1 and Examples 2-1 to 2-4, it can be learned that overall, for the secondary batteries with the negative electrode active material of a type within the range in this application and the I_{d}/I_{g} value of the carbon-based material within the range in this application, the charge time is shorter, the charge temperature rise is lower, and the capacity retention rate is higher at the charge rate of 10 C, and the positive electrode sheet and negative electrode sheet have lower breakage frequencies, indicating that good cycling kinetic performance of the secondary batteries can be achieved under the ultra-fast charge condition while processing reliability is ensured. FIG. 5 shows a Raman spectrum in Example 2-3. From FIG. 5, it can be learned that in a Raman spectrum of the high-kinetic negative electrode active material, a la/I_{g} value is relatively high, indicating good surface activity.

The type of the positive electrode active material usually affects cycling kinetic performance and processing reliability of the secondary battery. From Example 1-1, Example 2-5, and Example 2-6, it can be learned that overall, for the secondary batteries with the positive electrode active material of a type within the range in this application and the I_{d}/I_{g} value of the carbon-based material within the range in this application, the charge time is shorter, the charge temperature rise is lower, and the capacity retention rate is higher at the charge rate of 10 C, and the positive electrode sheet and negative electrode sheet have lower breakage frequencies, indicating that good cycling kinetic performance of the secondary batteries can be achieved under the ultra-fast charge condition while processing reliability is ensured.

It should be noted that in this specification, relational terms such as “first” and “second” are only used to distinguish one entity or operation from another entity or operation, and do not necessarily require or imply any such actual relationship or sequence between these entities or operations. Moreover, the terms “include”, “contain” or any other variant thereof are intended to cover non-exclusive inclusion, such that a process, method, article or device that includes a series of elements not only includes those elements, but also includes other elements not explicitly listed, or elements inherent to such process, method, article or device.

The various embodiments in this specification are described in a related manner, and for the same or similar parts in the various embodiments, reference may be made to each other. Each embodiment focuses on the differences from other embodiments.

The above descriptions are only preferred embodiments of this application and are not intended to limit this application. Any modifications, equivalent replacements, improvements, and the like made within the spirit and principles of this application shall be included in the protection scope of this application.

What is claimed is:

1. A secondary battery, comprising an electrode assembly, wherein the electrode assembly comprises a positive electrode sheet, a negative electrode sheet, and a separator; the positive electrode sheet comprises a positive electrode current collector and a positive electrode active material layer; the positive electrode active material layer comprises a positive electrode active material; the negative electrode sheet comprises a negative electrode current collector and a negative electrode active material layer; and the negative electrode active material layer comprises a negative electrode active material;
the positive electrode current collector extends to form a plurality of positive electrode tabs, the negative electrode current collector extends to form a plurality of negative electrode tabs, a coating weight of the positive electrode active material layer is W_{z}, and a coating weight of the negative electrode active material layer is W_{f}, wherein W_{z} and W_{f} satisfy: 1.6W_{f}≤W_{z}≤2.2W_{f}, and 3.25 mg/cm²≤W_{f}≤5.84 mg/cm²; and
Dᵥ99 of the positive electrode active material is 27 μm to 33 μm, and Dᵥ99 of the negative electrode active material is 23 μm to 28 μm.

2. The secondary battery according to claim 1, wherein the positive electrode sheet, the separator, and the negative electrode sheet are wound to form an electrode assembly; along the thickness direction of the electrode assembly, N₁ layers of positive electrode sheets are provided between two adjacent positive electrode tabs, N₂ layers of negative electrode sheets are provided between two adjacent negative electrode tabs, and N₁ and N₂ are independently selected from 0, 1, 2, or 3.

3. The secondary battery according to claim 1, wherein 6.49 mg/cm²≤W_{z}≤11.69 mg/cm².

4. The secondary battery according to claim 1, wherein 4.00 mg/cm²≤W_{f}≤5.19 mg/cm², and/or 8.00 mg/cm²≤W_{z}≤10.38 mg/cm².

5. The secondary battery according to claim 1, wherein the Dᵥ99 of the positive electrode active material is 28 μm to 31 μm, and/or the Dᵥ99 of the negative electrode active material is 24 μm to 26 μm.

6. The secondary battery according to claim 1, wherein the negative electrode active material comprises at least one of a carbon-based material, a silicon-based material, or a tin-based material; the carbon-based material comprises at least one of natural graphite, artificial graphite, soft carbon, hard carbon, or mesocarbon microbeads; the silicon-based material comprises at least one of elemental silicon, a silicon-carbon material, or a silicon-oxygen material; and the tin-based material comprises at least one of elemental tin, tin alloy, or tin oxide.

7. The secondary battery according to claim 6, wherein the negative electrode active material comprises the carbon-based material; the carbon-based material satisfies 0.13I_{d}/I_{g}≤1.0, wherein I_{d}/I_{g} is a peak intensity ratio of a d peak to a g peak measured through Raman test.

8. The secondary battery according to claim 1, wherein the positive electrode active material comprises at least one of lithium nickel cobalt manganese oxide, lithium nickel cobalt aluminum oxide, lithium iron phosphate, a lithium-rich manganese-based material, lithium cobalt oxide, lithium manganese oxide, lithium manganese iron phosphate, or lithium titanate.

9. The secondary battery according to claim 8, wherein the positive electrode active material further comprises a non-metal element; and the non-metal element comprises at least one of fluorine, phosphorus, boron, chlorine, silicon, or sulfur.

10. The secondary battery according to claim 1, wherein the separator comprises at least one of polyethylene (PE), polypropylene (PP), polyethylene terephthalate (PET), polyimide (PI).

11. An electric apparatus, comprising the secondary battery according to claim 1.

12. The electric apparatus according to claim 11, wherein the positive electrode sheet, the separator, and the negative electrode sheet are wound to form an electrode assembly; along the thickness direction of the electrode assembly, N₁ layers of positive electrode sheets are provided between two adjacent positive electrode tabs, N₂ layers of negative electrode sheets are provided between two adjacent negative electrode tabs, and N₁ and N₂ are independently selected from 0, 1, 2, or 3.

13. The electric apparatus according to claim 11, wherein 6.49 mg/cm²≤W_{z}≤11.69 mg/cm².

14. The electric apparatus according to claim 11, wherein 4.00 mg/cm²≤W_{f}≤5.19 mg/cm², and/or 8.00 mg/cm²≤W_{z}≤10.38 mg/cm².

15. The electric apparatus according to claim 11, wherein the Dᵥ99 of the positive electrode active material is 28 μm to 31 μm, and/or the Dᵥ99 of the negative electrode active material is 24 μm to 26 μm.

16. The electric apparatus according to claim 11, wherein the negative electrode active material comprises at least one of a carbon-based material, a silicon-based material, or a tin-based material; the carbon-based material comprises at least one of natural graphite, artificial graphite, soft carbon, hard carbon, or mesocarbon microbeads; the silicon-based material comprises at least one of elemental silicon, a silicon-carbon material, or a silicon-oxygen material; and the tin-based material comprises at least one of elemental tin, tin alloy, or tin oxide.

17. The electric apparatus according to claim 16, wherein the negative electrode active material comprises the carbon-based material; the carbon-based material satisfies 0.1≤I_{d}/I_{g}≤1.0, wherein I_{d}/I_{g} is a peak intensity ratio of a d peak to a g peak measured through Raman test.

18. The electric apparatus according to claim 11, wherein the positive electrode active material comprises at least one of lithium nickel cobalt manganese oxide, lithium nickel cobalt aluminum oxide, lithium iron phosphate, a lithium-rich manganese-based material, lithium cobalt oxide, lithium manganese oxide, lithium manganese iron phosphate, or lithium titanate.

19. The electric apparatus according to claim 18, wherein the positive electrode active material further comprises a non-metal element, and the non-metal element comprises at least one of fluorine, phosphorus, boron, chlorine, silicon, or sulfur.

20. The electric apparatus according to claim 11, wherein the separator comprises at least one of polyethylene (PE), polypropylene (PP), polyethylene terephthalate (PET), polyimide (PI).
